(19) United States
(12) Patent Application Publication
(10) Pub. No.: US 2017/0366124 A1
(43) Pub. Date: Dec. 21, 2017

(54) STEPPING MOTOR DRIVE DEVICE

(71) Applicant: TOSHIBA TEC KABUSHIKI KAISHA, Tokyo (JP)

(72) Inventor: Hiroshi Tsuchimoto, Numazu Shizuoka (JP)

(21) Appl. No.: 15/468,268

(22) Filed: Mar. 24, 2017

(30) Foreign Application Priority Data
Jun. 21, 2016 (JP) 2016-122974

(51) Int. Cl. H02P 8/18; H02P 8/12; B41J 2/32

(52) U.S. Cl. CPC H02P 8/18; B41J 2/32; H02P 8/12

(57) ABSTRACT

A stepping motor drive device which drives a stepping motor comprises a generation module configured to generate a current value waveform for rotating the stepping motor at a unit of a predetermined step angle; a drive module configured to excite the stepping motor using the current value waveform to rotate the stepping motor; and a control module configured to decrease a current value at a balance angle at which the stepping motor is stabilized at the time of non-excitation in the current value waveform of one rotation generated by the generation module.

### CROSS-REFERENCE TO RELATED APPLICATIONS

This application is based upon and claims the benefit of priority from Japanese Patent Application No. P2016-122974, filed Jun. 21, 2016, the entire contents of which are incorporated herein by reference.

### FIELD

Embodiments described herein relate generally to a stepping motor drive device and methods related thereto.

### BACKGROUND

Conventionally, retail stores often use a portable thermal printer driven by a battery. In the thermal printer, the battery is set as power supply, and thus taken-out electric power is restricted. Thus, printing speed is sped up in the taken-out electric power by carrying out a processing for changing the printing speed for each line according to the number of dots to be color-developed at the same time. For example, in a line where there are a large number of the dots to be color-developed, electric power is required to drive the heat generating elements, and thus the amount of consumption of total electric power is controlled by lowering a printing speed, that is, by decelerating a conveyance speed of a paper.

Further, since a small adjustment is required for alignment of a printing position at the time of conveyance of a paper, it is generally accepted to use a stepping motor capable of realizing correct positioning control.

In the stepping motor, however, there is an area (low speed area) in which a vibration phenomenon called a cogging is generated at a low speed side. As a result, when the printing speed is the low speed area, there is a possibility that printing unevenness is generated and printing precision is reduced due to the cogging phenomenon.

### DESCRIPTION OF THE DRAWINGS

FIG. 1 is a diagram schematically illustrating an outline structure of a thermal printer according to an embodiment;

FIG. 2 is a block diagram illustrating an example of the constitution of the thermal printer according to the embodiment;

FIG. 3 is a timing chart illustrating a general current value waveform in a W1-2 phase excitation mode;

FIG. 4 is a diagram schematically illustrating the constitution of a stepping motor;

FIG. 5 is a timing chart illustrating a current value waveform in the W1-2 phase excitation mode by a motor control circuit according to the present embodiment;

FIG. 6 is a timing chart illustrating another example of the current value waveform in the W1-2 phase excitation mode by the motor control circuit according to the present embodiment;

FIG. 7 is a timing chart illustrating another example of the current value waveform in the W1-2 phase excitation mode by the motor control circuit according to the present embodiment; and

FIG. 8 is a flowchart illustrating an example of a motor control processing carried out by the motor control circuit according to the present embodiment.

### DETAILED DESCRIPTION

In accordance with an embodiment, a stepping motor drive device which drives a stepping motor comprises a generation module, a drive module and a control module. The generation module generates a current value waveform for rotating the stepping motor at a unit of a predetermined step angle. The drive module excites the stepping motor using the current value waveform to rotate the stepping motor. The control module decreases a current value at a balance angle at which the stepping motor is stabilized at the time of non-excitation in the current value waveform of one rotation generated by the generation module.

Hereinafter, an embodiment of a stepping motor drive device according to the present invention is described in detail with reference to the accompanying drawings. In the embodiment described hereinafter, an example of applying the present invention to a portable thermal printer is described; however, the present invention is not limited to the embodiment.

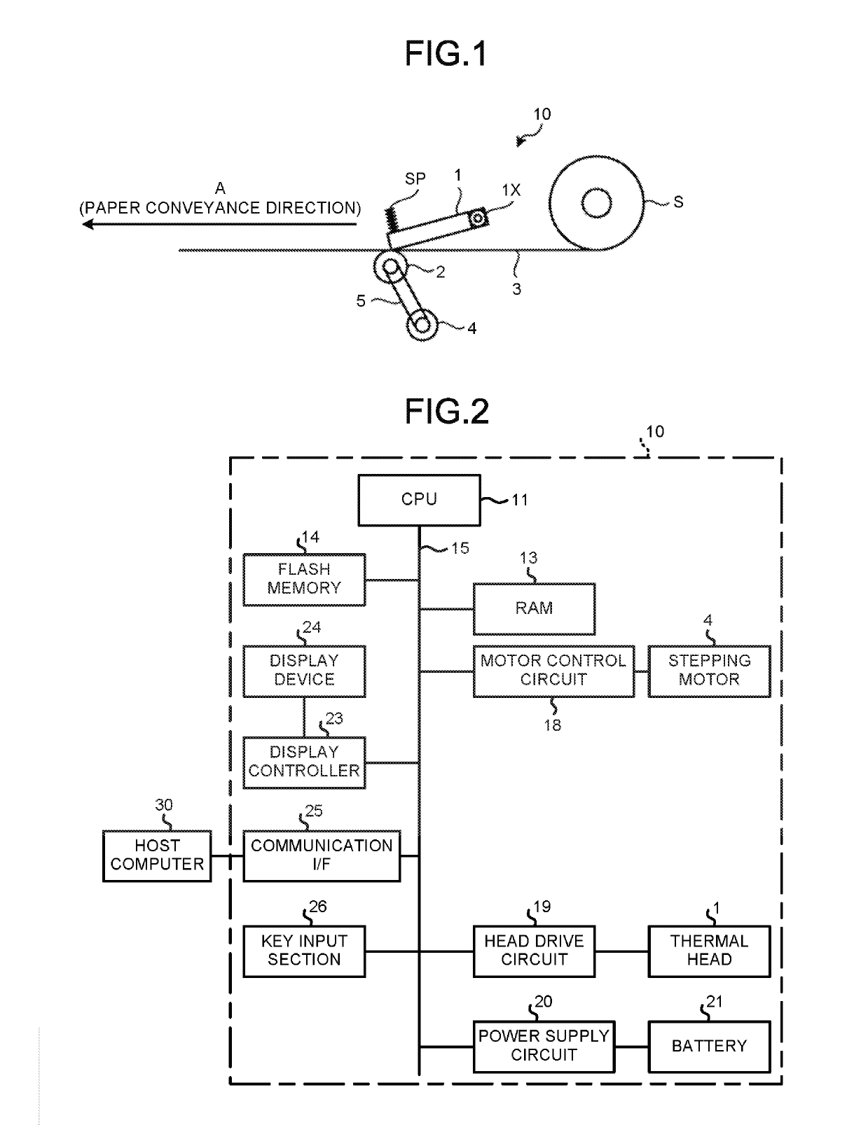

FIG. 1 is a diagram schematically illustrating an outline structure of a thermal printer 10 according to the embodiment. As shown in FIG. 1, the thermal printer 10 includes a line thermal head 1 and a platen roller 2. The line thermal head 1 and the platen roller 2 sandwich a paper 3 as an image receiving medium to be supplied as a wound continuous paper S, and are arranged at positions facing each other.

One end of the line thermal head 1 is rotationally supported by taking a rotation axis 1X as a rotation center. Further, the other end of the line thermal head 1 is energized by an energization member SP to be pressed against the platen roller 2

The platen roller 2 is connected with a stepping motor 4 via a belt 5 for transmitting rotation of the stepping motor 4 to the platen roller 2. Then, if the stepping motor 4 starts the rotation, the platen roller 2 is rotated in conjunction with the rotation of the stepping motor 4 via the belt 5. Furthermore, in the present embodiment, a case in which the stepping motor 4 is driven by a W1-2 phase excitation system is described.

The paper 3 is, for example, a thermal paper such as a label paper. The paper 3 is conveyed in a left direction (paper conveyance direction A) in FIG. 1 in a state of being sandwiched between the line thermal head 1 and the platen roller 2 with the rotation of the platen roller 2.

The line thermal head 1 includes a plurality of heat generating elements (not shown) arranged in a width direction of the paper 3. The line thermal head 1 enables a heat generating element corresponding to a location to be printed on the paper 3 among the plurality of the heat generating elements to generate heat. In this way, the line thermal head 1 prints an image (including characters and the like) corresponding to print data on the paper 3 that is being conveyed for each printing line.

The thermal printer 10 inputs a strobe signal to a heat generating element included in the line thermal head 1 to generate heat. The thermal printer 10 prints the image corresponding to the print data on the paper 3 by applying the heat to the paper 3 to develops the color of the paper 3. Furthermore, in a case in which the stepping motor 4 is rotated corresponding to a predetermined number of pulses, a distance of the rotation of the platen roller 2, that is, a conveyance distance of the paper 3 is determined by a gear ratio of a mechanism for transmitting the rotation of the stepping motor 4 to the platen roller 2.

FIG. 2 is a block diagram illustrating an example of the constitution of the thermal printer 10. As shown in FIG. 2, the thermal printer 10 includes a CPU (Central Processing Unit) 11 that executes various arithmetic processing to collectively control each section of the thermal printer 10. The CPU 11 is connected with memories including a RAM (Random Access Memory) 13 and a flash memory 14 via a system bus 15.

The flash memory 14 stores programs executed by the CPU 11 and data used for execution of the programs. The CPU 11 copies the programs stored in the flash memory 14 on the RAM 13 and executes the programs to control each section of the thermal printer 10.

An operation program executed by the thermal printer 10 of the present embodiment may be recorded in a computer-readable recording medium such as a CD-ROM, a FD (Flexible Disk), a CD-R, a DVD (Digital Versatile Disk) and the like in the form of installable or executable file to be provided.

Furthermore, the operation program executed by the thermal printer 10 of the present embodiment may be stored on a computer connected with a network such as the Internet and provided by being downloaded via the network. Further, the operation program executed by the thermal printer 10 of the present embodiment may be provided or distributed via the network such as the Internet.

The RAM 13 temporarily stores various kinds of information. Further, the RAM 13 is used as a print buffer in which the print data (image data) to be printed on the paper 3 is temporarily stored. The print data is data of a print object received from a host computer 30. Furthermore, the print data may be temporarily stored in the flash memory 14.

Further, the CPU 11 is connected with a motor control circuit 18, a head drive circuit 19 and a power supply circuit 20. The motor control circuit 18 corresponds to the stepping motor drive device of the present embodiment. The motor control circuit 18 which is controlled by the CPU 11 drives the stepping motor 4 to rotate. Furthermore, drive control of the stepping motor 4 by the motor control circuit 18 is described later.

The head drive circuit 19 which is controlled by the CPU 11 is in a state capable of outputting the strobe signal to a heat generating element included in the line thermal head 1 in response to the print data stored in the RAM 13 to cause a drive current to flow to the heat generating element included in the line thermal head 1. The head drive circuit 19 determines the heat generating element to which the drive current flows actually according to a logical product of the strobe signal and the print data to carry out drive. In this way, the image corresponding to the print data is printed on the paper 3. The power supply circuit 20 supplies electric power stored in a battery 21 to each section of the thermal printer 10.

Further, the CPU 11 is connected with a display controller 23, a communication interface 25 and a key input section 26. The display controller 23 which is controlled by the CPU 11 controls display of information on a display device 24. The display device 24 displays various kinds of information such as a printing condition and the like.

The communication interface (I/F) 25 is an interface for carrying out communication with an external device such as the host computer 30. In the present embodiment, the communication interface 25 carries out communication with a communication interface arranged in the host computer 30 through infrared communication such as IrDA, a USB (Universal Serial Bus), a LAN (Local Area Network), RS-232C and a Bluetooth (registered trademark).

The key input section 26 includes various keys for inputting various kinds of information to the thermal printer 10 by a user.

The host computer 30 is a device for executing an arithmetic processing according to an operation input by the user, for example, a personal computer (PC), a mobile phone and a handy terminal.

In the thermal printer 10 with the foregoing constitution, the battery 21 is set as power supply, and thus taken-out electric power is restricted. Thus, the CPU 11 carries out a processing for changing a printing speed for each line according to the number of dots to be color-developed at the same time to speed up the printing speed in the taken-out electric power. For example, in a line where there are a large number of the dots to be color-developed, electric power is required for the heat generating element, and thus the CPU 11 controls an amount of consumption of total electric power by lowering the printing speed, that is, by decelerating a conveyance speed of the paper 3.

Next, the drive control of the stepping motor 4 by the motor control circuit 18 is described. The stepping motor 4 driven and controlled by the motor control circuit 18, which is also called a pulse motor, is applied with a pulse signal (current value waveform) to be rotated at a unit of a predetermined step angle.

The motor control circuit 18 functions as a generation module that generates a current value waveform for rotating the stepping motor 4 at a unit of the predetermined step angle under the control of the CPU 11. Further, the motor control circuit 18 functions as a drive module that excites the stepping motor 4 using the current value waveform to rotate the stepping motor 4. More specifically, the motor control circuit 18 applies the current value waveform to the stepping motor 4 at a predetermined pulse speed to rotate the stepping motor 4 at a desired rotation speed.

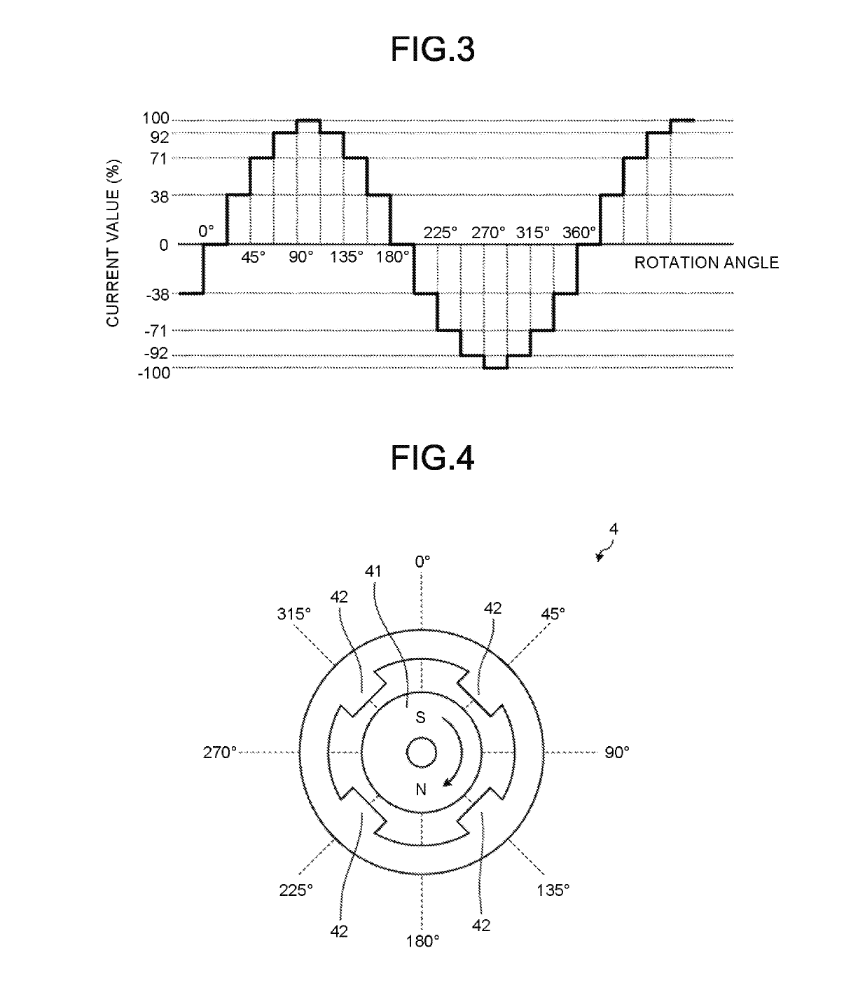

FIG. 3 is a timing chart illustrating a general current value waveform in a W1-2 phase excitation mode. Furthermore, FIG. 3 illustrates the current value waveform of one phase of two phases.

As shown in FIG. 3, in the W1-2 phase, the current value waveform rotates at a unit of a step angle of 22.5 degrees, and rotates 360 degrees in 16 steps. Further, one cycle consisting of the 16 steps is equivalent to a rotation amount of the stepping motor 4, and the stepping motor 4 can be smoothly driven with the change of a current value in each step.

Incidentally, in the stepping motor 4, there is an area (low speed area) in which a phenomenon called a cogging is generated at a low speed side. The low speed area is a rotation speed of, for example, 200 pps or less, and refers to a rotation speed at which the cogging is generated in a case in which the stepping motor 4 is driven with the current value waveform in FIG. 3. Hereinafter, the cogging generated in the low speed area is described with reference to FIG. 4.

FIG. 4 is a diagram schematically illustrating the constitution of the stepping motor 4. The stepping motor 4 includes a rotor 41 formed by a magnet and the like and stators 42 formed by a coil and the like. In FIG. 4, an example of arranging the stators 42 respectively at 45 degrees, 135 degrees, 225 degrees and 315 degrees is illustrated, and the rotor 41 is rotationally arranged at the center of the stepping motor 4. Then, the foregoing current value waveform is switched in a predetermined order and flows to each stator 42, and in this way, the stator 42 is excited, and the rotor 41 is rotated by being drawn towards the excited stator 42.

However, if the stepping motor 4 (rotor 41) is rotated at a low speed, a phenomenon called a cogging in which magnetic attraction force (repellent force) of the stator 42 strongly works is generated at an angle at which the rotor 41 is stabilized at the time of non-excitation. The angle at which the rotor 41 is stabilized at the time of the non-excitation is an angle corresponding to a setting position of the stator 42, and hereinafter, referred to as a balance angle. For example, in the case of FIG. 4, the cogging is generated at angles (balance angles) of 45 degrees, 135 degrees, 225 degrees and 315 degrees. The rotation speed of the rotor 41 becomes uneven in the vicinity of the balance angle due to the cogging. Thus, if the cogging is generated at the time of the printing, the cogging becomes the main cause of the generation of the printing unevenness and decrease in print quality.

Thus, in a case in which the motor control circuit 18 of the present embodiment rotates the stepping motor 4 in the low speed area, control for locally decreasing the current value in the vicinity of the balance angle is carried out in the current value waveform of one cycle described above. In this way, the motor control circuit 18 decreases the magnetic attraction force of the stator 42 in the vicinity of the balance angle.

Hereinafter, operations of the motor control circuit 18 are described with reference to FIG. 5. FIG. 5 is a timing chart illustrating a current value waveform in the W1-2 phase excitation mode by the motor control circuit 18. Furthermore, in FIG. 5, a case in which the stators 42 of the stepping motor 4 are arranged at respective angle positions of 45 degrees, 135 degrees, 225 degrees and 315 degrees as shown in FIG. 4 is assumed.

As shown in FIG. 5, the motor control circuit 18 locally decreases the current value in the vicinity of the balance angles 45 degrees, 135 degrees, 225 degrees and 315 degrees corresponding to the setting positions of the stator 42. In more detail, the motor control circuit 18 decreases the current value to ½ of the current value shown in FIG. 3 in each of sections A1-A4 serving as predetermined angle ranges that take the respective balance angles as reference. The amount of the decrease of the current value is not limited to ½, and it is more preferable that the amount is determined according to a specification of the stepping motor 4. Furthermore, in 180 degrees-360 degrees, since the current value is minus, the current value is apparently increased locally in the sections A3 and A4. Each of the sections A1-A4 is referred to as a current value decrease section.

The current value waveform shown in FIG. 5 is held in, for example, a recording medium (not shown) as table information associating the angle with the current value. Then, at the time the stepping motor 4 is rotated at a low speed, the motor control circuit 18 drives the stepping motor 4 with the current value waveform shown in FIG. 5 with reference to the table information. In this way, the motor control circuit 18 can decrease the magnetic attraction force of the stator 42 in the vicinity of the setting position of the stator 42, and thus the generation of the cogging can be efficiently suppressed.

The size of the current value decrease section is not specifically limited, and is possible to randomly set according to a specification and an excitation system of the stepping motor 4. For example, the current value decrease section may be set within a range of the step angle before and after the balance angle as the reference. In the current value waveform shown in FIG. 5, within a range of the step angle (for example, 22.5 degrees˜67.5 degrees) before and after the balance angle as the reference, an example in which a proportion (hereinafter, referred to as an occupancy ratio) of the current value decrease section is about 80% is illustrated. Furthermore, the occupancy ratio of the current value decrease section is not limited to the example, and is possible to randomly set.

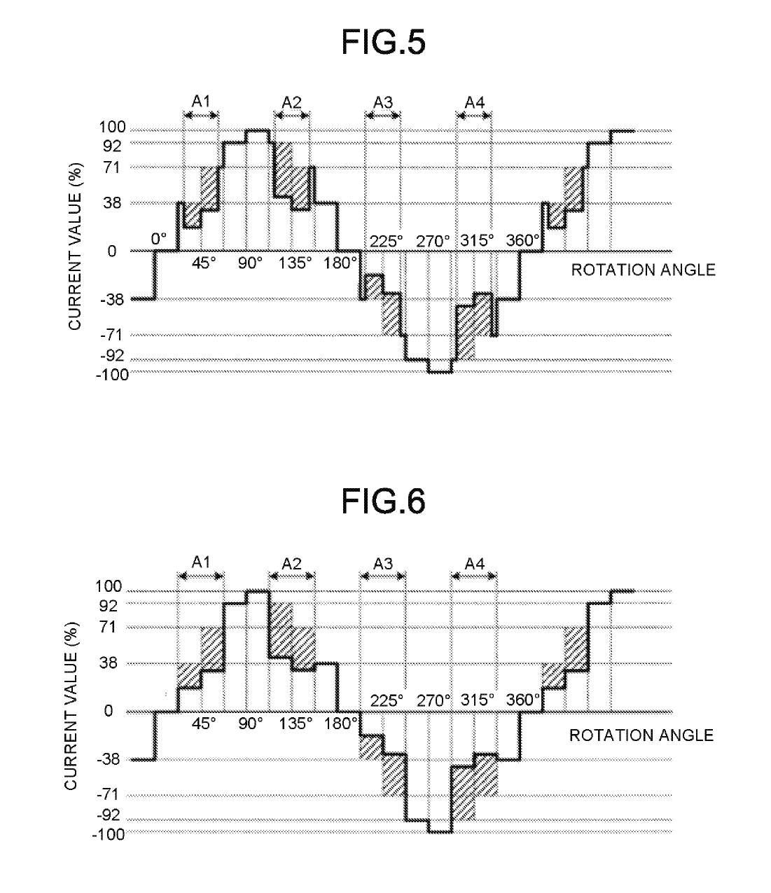

For example, by setting the occupancy ratio of the current value decrease section to 100%, in the whole range of the step angle before and after the balance angle as the reference, the current value may be decreased. FIG. 6 is a timing chart illustrating another example of the current value waveform in the W1-2 phase excitation mode by the motor control circuit 18. In the current value waveform, an example in which the occupancy ratio of the current value decrease section is set to 100% is illustrated.

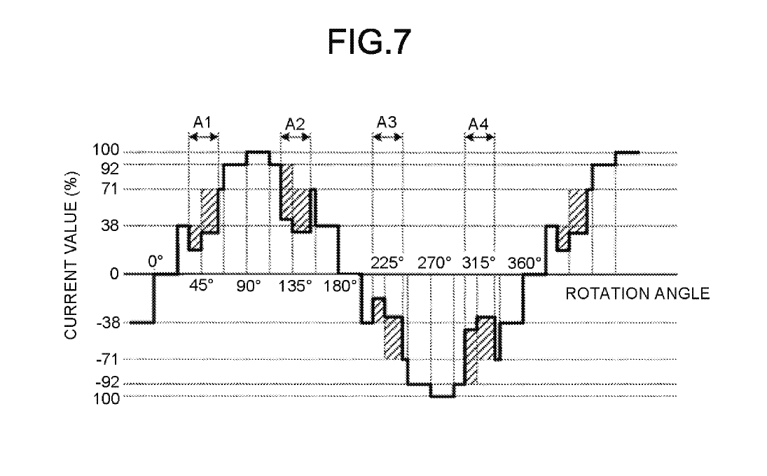

Further, in FIG. 5 (FIG. 6), by setting the balance angle as the center, the current value decrease section is determined in such away as to be symmetrical before and after the balance angle; however, the present invention is not limited to this, and the current value decrease section may be determined in such away as to be unsymmetrical before and after the balance angle. FIG. 7 is a timing chart illustrating another example of the current value waveform in the W1-2 phase excitation mode by the motor control circuit 18. In FIG. 7, an example in which the current value decrease section may be determined in such a way as to be unsymmetrical before and after the balance angle is illustrated. In this example, the current value decrease section is determined in such a way that a second part after the balance angle is larger than a first half. Furthermore, a ratio of the first half and the second half is not specifically limited, and it is preferred to determine the ratio according to the specification and the excitation system of the stepping motor 4.

Further, the motor control circuit 18 may dynamically change a decrease amount of the current value in the current value decrease section and the occupancy ratio of the current value decrease section according to the rotation speed of the stepping motor 4. For example, the motor control circuit 18 may control to increase the decrease amount in the current value decrease section and the occupancy ratio of the current value decrease section as the rotation speed of the stepping motor 4 becomes the low speed. Furthermore, in a case of adopting this constitution, the motor control circuit 18 holds the table information associating the angle and the current value for each rotation speed of the stepping motor 4.

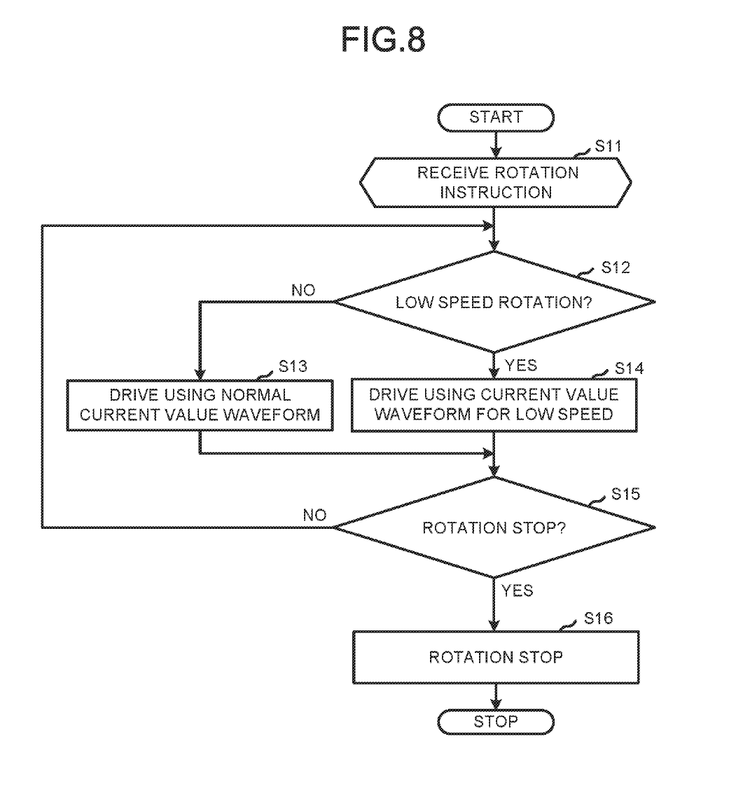

Next, a motor control processing carried out by the motor control circuit 18 is described with reference to FIG. 8. FIG. 8 is a flowchart illustrating an example of the motor control processing carried out by the motor control circuit 18.

If the rotation drive of the stepping motor 4 is instructed by the CPU 11 (Act S11), the motor control circuit 18 determines whether or not the rotation of the stepping motor 4 is low speed rotation of which the rotation speed is included in the low speed area (Act S12). If the rotation is not the low speed rotation (No in Act S12), the motor control circuit 18 drives the stepping motor 4 to rotate using a normal current value waveform (Act S13), and proceeds to a processing in Act S15. The normal current value waveform refers to the current value waveform described in FIG. 3.

On the other hand, if the rotation is the low speed rotation (Yes in Act S12), the motor control circuit 18 drives the stepping motor 4 to rotate using a current value waveform for low speed (Act S14), and proceeds to a processing in Act S15. The current value waveform for low speed refers to the current value waveform described in FIG. 5-FIG. 7 which locally decreases the current value in the vicinity of the balance angle.

Next, in Act S15, the motor control circuit 18 determines whether or not rotation stop is instructed from the CPU 11 (Act S15). If the rotation stop is not instructed (No in Act S15), the motor control circuit 18 returns to the processing in Act S12, and executes the processing in Act S13 or S14 without a break according to the rotation speed instructed from the CPU 11.

Then, if the rotation stop is instructed from the CPU 11 (Yes in Act S15), the motor control circuit 18 stops the rotation of the stepping motor 4 (Act S16), and ends the present processing.

As stated above, in the thermal printer 10, in a case of carrying out the printing in the low speed area, the stepping motor 4 is driven to rotate using the current value waveform for locally decreasing the current value in the vicinity of the balance angle. In this way, the thermal printer 10 can convey the paper 3 at a low speed in a state of suppressing the cogging, and thus can improve the print quality.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the foregoing embodiment, the present invention is applied to the rotation drive control of the stepping motor 4 relating to paper conveyance in the thermal printer 10; however, the device serving as the application destination and the use are not limited to the example.

Further, in the foregoing embodiment, as the excitation system of the stepping motor 4, the W1-2 phase excitation is described; however, the excitation system is not limited to this, and it is also possible to apply 2 phase excitation or 1-2 phase excitation and 2W1-2 phase excitation to other excitation systems.

Further, in the foregoing embodiment, the motor control circuit 18 is the main body to control the stepping motor 4; however, the present invention is not limited to this, and the CPU 11 is the main body to control the stepping motor 4 via the motor control circuit 18. In this way, the CPU 11 cooperates with a program stored in the flash memory 14 to function as the control module.

What is claimed is:

1. A stepping motor drive device which drives a stepping motor, comprising:
a generation module configured to generate a current value waveform for rotating the stepping motor at a unit of a predetermined step angle;
a drive module configured to excite the stepping motor using the current value waveform to rotate the stepping motor; and
a control module configured to decrease a current value at a balance angle at which the stepping motor is stabilized at the time of non-excitation in the current value waveform of one rotation generated by the generation module.

2. The stepping motor drive device according to claim 1, wherein
the control module sets an angle corresponding to a setting position of a stator comprised in the stepping motor to the balance angle.

3. The stepping motor drive device according to claim 1, wherein
the control module decreases the current value within a range of a step angle located before and after the balance angle.

4. The stepping motor drive device according to claim 2, wherein
the control module decreases the current value within a range of a step angle located before and after the balance angle.

5. The stepping motor drive device according to claim 3, wherein
the control module changes a section length for decreasing the current value according to a rotation speed of the stepping motor.

6. The stepping motor drive device according to claim 1, wherein
the control module decreases the current value in the vicinity of the balance angle when rotating the stepping motor in a low speed area.

7. The stepping motor drive device according to claim 1, wherein
the low speed area has a rotational speed of 200 pps or less.

8. A printer comprising the stepping motor drive device according to claim 1.

9. The printer according to claim 8, wherein the printer is a thermal printer.

10. A stepping motor method for driving a stepping motor, comprising:
generating a current value waveform for rotating the stepping motor at a unit of a predetermined step angle;
exciting the stepping motor using the current value waveform to rotate the stepping motor; and
decreasing the current value at a balance angle at which the stepping motor is stabilized at the time of non-excitation in the current value waveform of one rotation.

11. The stepping motor method according to claim 10, further comprising:
setting an angle corresponding to a setting position of a stator to the balance angle.

12. The stepping motor method according to claim 10, further comprising:
decreasing the current value within a range of a step angle located before and after the balance angle.

13. The stepping motor method according to claim 11, further comprising:
decreasing the current value within a range of a step angle located before and after the balance angle.

14. The stepping motor method according to claim 12, further comprising:
changing a section length for decreasing the current value according to a rotation speed of the stepping motor.

15. The stepping motor method according to claim 10, further comprising:
decreases the current value in the vicinity of the balance angle when rotating the stepping motor in a low speed area.

16. The stepping motor method according to claim 10, wherein
the low speed area has a rotational speed of 200 pps or less.
